(19) United States
(12) Patent Application Publication
(10) Pub. No.: US 2018/0134998 A1
(43) Pub. Date: May 17, 2018

(54) Lavatory Cleansing Block

(71) Applicant: Henkel Limited, Hertfordshire (GB)

(72) Inventors: Russell Norman, Thetford Norfolk (GB); Brian Wilson, Glasgow (GB); Clare Jackson, Thetford Norfolk (GB); Janice Kavaney, Kings Lynn Norfolk (GB)

(21) Appl. No.: 15/872,118

(22) Filed: Jan. 16, 2018

Related U.S. Application Data
(63) Continuation of application No. PCT/GB2016/052125, filed on Jul. 14, 2016.

(30) Foreign Application Priority Data
Jul. 16, 2015 (GB) 1512447.2

(51) Int. Cl. C11D 17/00; C11D 3/22; C11D 3/40; C11D 3/382; C11D 3/20; C11D 1/37; C11D 3/12

(52) U.S. Cl. CPC C11D 17/0056; C11D 3/225; C11D 3/40; C11D 1/24; C11D 3/2003; C11D 1/37; C11D 3/122; C11D 3/382

(57) ABSTRACT

A lavatory cleansing block including: an alkane sulfonate; a carboxymethylcellulose; a hydrophobe; and optionally a dye, wherein the alkane sulfonate is present in an amount of 15 to 40% by weight of the total block, the weight ratio of alkane sulfonate to carboxymethylcellulose is 3:1 to 8:1 and the total weight of the block is less than 25 g.

### FIELD OF THE INVENTION

The present invention relates to a lavatory cleansing block, to a packaged product comprising the lavatory cleansing block and to method for preparing the cleansing block. The invention also relates to a composition for preparing the blocks and to use of the composition to prepare the blocks. Additionally, the invention relates to a method of cleansing a lavatory appliance using the blocks of the invention.

### BACKGROUND OF THE INVENTION

Lavatory cleansing blocks are generally used in either one of two modes, either as an “ITC” or “in the cistern” mode, or as an “ITB” or “in the bowl” mode. When used in the cistern, the block is placed in the cistern or toilet tank wherein it dissolves over a period of time and thus delivers active agents to the water present in the cistern which is periodically used to flush the toilet bowl. The block is generally placed in the interior of the cistern as a tablet or other self-supporting shape. When used in the bowl, the block is generally placed within the bowl, usually using a cage or holder, so that the active agents are contacted with water flushed into the lavatory appliance, especially the bowl of a toilet, or the interior of a urinal. In this set up the block is dissolved with each flush of water passing though the appliance such that an amount of active agent is dispensed to the toilet bowl, urinal, etc.

The quantity of ingredients delivered into the toilet bowl during each flush cycle of the toilet will in turn affect the actual and perceived performance of the block. The perceived benefit of a block, usually the result of the observation of color and/or foaming, can be as important as the actual effect of the active ingredients in determining the commercial success of a block. The extent to which a cleansing block provides a cleansing action per se depends on, for example, the active ingredients used, the overall composition of the block, the nature of the block and the quantity dosed into the lavatory during a flush cycle. Similarly the perceived performance of a block depends on the surfactants and/or dyes used, the overall composition and nature of the block and the quantity dosed.

For typical domestic use, the preferred toilet life of the block is about 28 days. The toilet life of the block is governed in particular by the amount of material in the block and the rate at which the block dissolves in the flush water, and this depends primarily on the composition of the block. The toilet life will also depend in part on the hardness of the flush water, the ambient temperature, the frequency of flushing and even the toilet design. These factors are well known in the art and the blocks can be tested against a range of conditions when determining a suitable composition for a particular market.

There is a considerable volume of prior art describing different lavatory cleansing blocks which address various problems such as block instablity, uncontrolled release of active agent especially towards the end of toilet life, poor perceived performance, poor handling behaviour and manufacturing problems. Many of these problems arise because it is difficult to balance the effective and/or perceived cleansing performance of a block against the desired toilet life, whilst maintaining a viable and economic block size and even block performance over the majority of the lifetime of the block.

U.S. Pat. No. 4,861,511, for example, discloses a toilet block composition which is capable of preventing mineral staining of toilet bowls, whilst simultaneously cleaning the toilet bowls. GB 2322632 and U.S. Pat. No. 4,269,723 each disclose ITC or ITB toilet cleaning blocks. The toilet block composition disclosed in GB 2322632 comprises anionic detergents, non-ionic detergents, sodium carboxymethylcellulose, a solubility regulator, a fragrance and a dye. The toilet block composition disclosed in U.S. Pat. No. 4,269,723 comprises organic surface active agents, a perfume, a dye and a binder, which can be sodium carboxymethylcellulose. There is, however, no disclosure in any of GB 2322632, U.S. Pat. No. 4,269,723 or U.S. Pat. No. 4,861,511 of the amount of residue the toilet blocks leave behind at the end of their toilet lives or the release rates of active agents and/or dyes from those toilet blocks.

Thus there is still a need for further and improved toilet blocks. One problem with existing toilet blocks is that they can leave behind a residue, for example in the cistern or in the bowl depending on the type of block, that is perceived as a negative by the user. This is particularly apparent when a block contains a dye to show that the block is having an effect by coloring the flush water, as any residue left after the expiry of the useful life of the block will itself be highly colored. This problem is further exacerbated by toilet blocks that are used in hard water conditions.

### BRIEF SUMMARY OF THE INVENTION

Viewed from a first aspect the present invention provides a lavatory cleansing block comprising: an alkane sulfonate; a carboxymethylcellulose; a hydrophobe; and optionally a dye, wherein said alkane sulfonate is present in an amount of 15 to 40% by weight of the total block, the weight ratio of alkane sulfonate to carboxymethylcellulose is 3:1 to 8:1 and the total weight of the block is less than 25 g.

Viewed from a further aspect the present invention provides a packaged product comprising a block as hereinbefore described.

Viewed from a further aspect the present invention provides a method for preparing a block as hereinbefore described, comprising:

(i) preparing a mixture of an alkane sulfonate, a carboxymethylcellulose, a hydrophobe and optionally a dye;

(ii) extruding said mixture into rod or bar form; and

(iii) cutting said rod or bar into said blocks.

Viewed from a further aspect the present invention provides a composition comprising:

15 to 40 wt % alkane sulfonate;
2 to 15 wt % carboxymethylcellulose;
2 to 10 wt % hydrophobe; and
0.5 to 10 wt %, dye,
wherein the weight ratio of alkane sulfonate to carboxymethylcellulose is 3:1 to 8:1.

Viewed from a further aspect the present invention provides the use of a composition comprising an alkane sulfonate, a carboxymethylcellulose, a hydrophobe and a dye in the preparation of a lavatory cleansing block as hereinbefore described.

Viewed from a further aspect the present invention provides a method of cleansing a lavatory, comprising: placing a lavatory cleansing block as hereinbefore described in the cistern of said lavatory.

Viewed from a further aspect the present invention provides the use of a lavatory cleansing block as hereinbefore described for cleansing a lavatory, wherein said block is placed in the cistern of said lavatory.

### DEFINITIONS

Block as referred to herein is a solid block which is a solid at 25° C. and atmospheric pressure.

Toilet life as referred to herein is the number of days for which a block is effective when tested in a UK style, 9 litre Magnia Armitage Shanks flush toilet cistern with a domestic flush pattern of 12 flushes per day, at 16 to 19° C. The end of life is preferably determined visually by the absence of foam and/or color.

Hard water as referred to herein is water containing more than 200 mg of calcium carbonate per litre.

Soft water as referred to herein is water containing less than 10 mg of calcium carbonate per litre.

Acid Blue 9 as referred to herein is ethyl-[4-[[4-[ethyl-[(3-sulfophenyl)methyl]amino]phenyl]-(2-sulfophenyl)methylidene]-1-cyclohexa-2,5-dienylidene]-[(3-sulfophenyl)methyl]azanium, also known as Brilliant Blue FCF.

### BRIEF DESCRIPTION OF THE DRAWINGS

These and other aspects of the invention will now be further described, by way of example only, with reference to the accompanying figures in which:

FIG. 1 is a diagram to describe the automatic flush protocol employed to test the blocks of the present invention;

FIGS. 2a and 2b are photographs showing the residue remaining in the cistern at the end of the useful life of a 24 g and a 38 g block respectively when tested using a supply of hard water;

FIGS. 3a, 3b, 3c and 3d are photographs showing the post-flush performance of a 24 g block at day 11, day 22, day 31 and day 34 respectively of a test using a supply of hard water;

FIGS. 4a, 4b, 4c and 4d are photographs showing the post-flush performance of a 38 g block at day 5, day 20, day 29 and day 44 respectively of a test using a supply of hard water;

FIGS. 5a and 5b are photographs showing the residue remaining in the cistern at the end of the useful life of a 24 g and a 38 g block respectively when tested using a supply of soft water;

FIGS. 6a, 6b, 6c and 6d are photographs showing the post-flush performance of a 24 g block at day 5, day 21, day 24 and day 28 respectively of a test using a supply of soft water;

FIGS. 7a, 7b and 7c are photographs showing the post-flush performance of a 38 g block at day 5, day 20 and day 29 respectively of a test using a supply of soft water.

FIG. 8 is a graph showing the dye release over time of a 24 g block and a 38 g block when tested using a supply of both hard and soft water. The graph also shows the useful life of each of the blocks when tested under both sets of conditions.

### DETAILED DESCRIPTION OF THE INVENTION

The lavatory cleansing block of the present invention comprises:

an alkane sulfonate;
a carboxymethylcellulose;
a hydrophobe; and
optionally a dye,
wherein the alkane sulfonate is present in an amount of 15 to 40% by weight of the total block, the weight ratio of alkane sulfonate to carboxymethylcellulose is 3:1 to 8:1 and the total weight of the block is less than 25 g.

Preferably the block of the present invention comprises a dye.

The block of the present invention is therefore a relatively small block by weight which contains a relatively high concentration of alkane sulfonate. Despite its relatively small size, the actual release of active agent, preferably anionic surfactant, and/or the perceived release of active agent, preferably anionic surfactant, as indicated by foaming or color intensity, over a 4 week period is comparable to that of a significantly larger commercially available block, e.g. a block of 38 gin weight. This is entirely unexpected because the smaller blocks of the present invention have a significantly smaller surface area than the larger commercially available blocks and thus would be expected to release significantly less active agent as well as less dye and less anionic surfactant that causes foaming. Without wishing to be bound by theory, it is thought that the higher than expected release of active agent as well as dye and anionic surfactant achieved with the blocks of present invention, is due to the presence of carboxymethylcellulose therein.

The blocks of the present invention have a total weight of less than 25 g. When a block is less than 25 g in weight, there is no need to label any water soluble film used to protect the block. This is highly advantageous as it eliminates a processing step during manufacture. Particularly preferably the blocks of the present invention have a total weight of 5 to 24.5 g, more preferably 15 to 24.0 g and still more preferably 20 to 24.0 g.

Preferred blocks of the present invention have a total surface area of 25 to 55 cm², more preferably 30 to 50 cm², still more preferably 35 to 45 cm² and yet more preferably 40 to 45 cm². In preferred uses of the blocks of the present invention, however, one face of the block lies against the lavatory appliance. Thus further preferred blocks of the present invention have a total effective surface area (i.e. surface area exposed to water in use) of 15 to 45 cm², more preferably 20 to 40 cm², still more preferably 25 to 35 cm² and yet more preferably 27 to 35 cm². The relatively small surface area of the blocks would generally be expected to reduce the actual and perceived release of components of the block in flush water, but as discussed herein, this is not the case with the blocks of the present invention.

The blocks of the present invention may be formed into any 3D shape. Preferably, however, the blocks of the invention have a circular, square or rectangular cross section and in particular a circular cross section. The largest dimension of the cross section is preferably 2.0 to 6.0 cm, more preferably 3.0 to 4.5 cm, still more preferably 3.1 to 4.4 cm. When the cross section is circular, it preferably has a diameter of 2.0 to 6.5 cm, more preferably 2.5 to 5.0 cm and still more preferably 3.5 to 4.6 cm. The height or depth of the blocks of the invention (e.g. the distance between parallel cross sections) is preferably 0.5 to 5.5 cm, more preferably 0.75 to 3.5 cm and still more preferably 0.9 to 2.0 cm

The blocks of the present invention are concentrated blocks. Thus the blocks comprise relatively high levels of anionic surfactant which is the active agent present therein. The blocks of the present invention comprise an alkane sulphonate, preferably a secondary alkane sulphonate and/or an alkyl aryl sulphonate. As used herein the term secondary alkane sulphonate is used to refer to dialkyl sulphonates. Alkane sulfonates also cause foaming and thus are additionally responsible for producing foam in the toilet bowl which is an effect that users of the blocks of the present invention perceive as a sign of activity.

Typically alkane sulphonates, e.g. secondary alkane sulphonates and alkyl aryl sulphonates, are provided in the form of their sodium salts. Examples of alkyl aryl sulphonates that may be present in the compositions of the present invention are those having an alkyl group that contains 6 to 24 carbon atoms and an aryl group selected from benzene, toluene, and xylene. An example of a suitable alkyl aryl sulphonate is sodium alkyl benzene sulphonate such as sodium dodecyl benzyl sulphonate. Other exemplary alkyl aryl sulphonates include xylene sulphonate and cumene sulphonate. Examples of dialkyl sulphonates that may be present in the compositions of the present invention are C₆₋₂₄ dialkyl sulphonates. A representative example is sodium C₁₄₋₁₇ sec-alkyl sulphonate.

Preferably the alkane sulphonate, e.g. secondary alkane sulphonate and/or alkyl aryl sulphonate, is present in an amount of 15 to 35%, more preferably 20 to 32% and still more preferably 22 to 30% by weight of the total block. The amount of alkane sulphonate present in the block has been found to influence the hardness of the block and its susceptibility to disintegration. Ideally the blocks of the present invention retain their shape for as long as possible during their toilet life and do not disintegrate readily. Once disintegration has occurred, the constituents of the block are rapidly flushed though and out of the toilet. An appropriate balance for the amount of alkane sulphonate is therefore important to the performance of the block including its toilet life.

The blocks of the present invention also comprise carboxymethylcellulose. Preferably the blocks of the present invention comprise carboxymethylcellulose in place of guar gum. Thus preferred blocks of the present invention comprise substantially no (e.g. comprise no) guar gum. Without wishing to be bound by theory, it is believed that the presence of carboxymethylcellulose in the blocks of the invention is advantageous as it is better at releasing the other components of the block therefrom. It is therefore thought that it is the presence of the carboxymethylcellulose which enables a greater than expected release of anionic surfactant and dye during use of the blocks of the present invention and which allows for the weight and surface area of the blocks to be decreased without compromising the actual or perceived cleansing effect. It is also thought that compared to guar gum, carboxymethylcellulose has a lesser tendency to form an insoluble matrix that traps components of the block. These trapped components are what are present in the residue at the end of the toilet life of the block. The carboxymethylcellulose is therefore believed to be responsible for lowering the residue levels present at the end of toilet life.

Preferably the carboxymethylcellulose used in the blocks of the present invention has a viscosity range of 1000 to 8000 cP, more preferably 1500 to 6000 cP and still more preferably 2500-4500 cP when tested as a 1% solution in water at 25° C., 30 rpm and using a rheometer, e.g. with a LV spindle. Preferably the carboxymethylcellulose has a degree of substitution of 0.6 to 1.45, more preferably 0.75 to 0.95 and still more preferably 0.8-0.95. Preferably the carboxymethylcellulose has a pH of 6.0 to 9.0 and more preferably 6.5 to 8.5. Preferably the carboxymethylcellulose has a weight average molecular weight of 150,000 to 2,000,000 g, more preferably 200,000 to 1,800,000 g and still more preferably 220,000 to 1,800,000 g.

In preferred blocks of the invention, the carboxymethylcellulose is present in an amount of 2 to 15 wt %, more preferably 3 to 10 wt % and still more preferably 4 to 9 wt % based on the total weight of the block. The weight ratio of alkane sulfonate to carboxymethylcellulose is 3:1 to 8:1, preferably 4:1 to 6:1 and more preferably 4.5:1 to 5.5:1. At this ratio, it is believed that the release rate of alkane sulfonate is optimised for a 4 week block.

The blocks of the present invention preferably comprise a dye. As used herein the term dye refers to any compound that imparts a color when it is contacted with water. When the toilet comprising the block of the present invention is flushed, the dye is released and colors the water in the toilet bowl. This is the primary indicator to users of the blocks that the block is working. It is also often used to determine the end of the life of the block. Thus when no color is produced on flushing, the block is assumed to be consumed.

Many dyes suitable for use in the present invention are commercially available. Preferably the dye is water soluble. Still more preferably the dye is an acid dye and in particular an anionic acid dye. Exemplary dyes include Alizarine Light Blue B (C.I. 63010), Carta Blue VP(C.I. 24401), Acid Green 2G (C.I. 42085), Astragon Green D (C.I. 42040) Supranol Cyanine 7B (C.I. 42675), Maxilon Blue 3RL (C.I. Basic Blue 80), acid yellow 23, acid violet 17, a direct violet dye (Direct violet 51), Drimarine Blue Z-RL (C.I. Reactive Blue 18), Alizarine Light Blue H-RL (C.I. Acid Blue 182), FD&C Blue No. 1, FD&C Green No. 3 and Acid Blue No. 9. Preferably the dye is a blue dye. A preferred dye for use in the blocks of the invention is Acid Blue 9.

In preferred blocks of the invention, the dye is present in an amount of 0.5 to 10%, more preferably 2 to 7.5% and still more preferably 3 to 6% by weight of the total block. Preferably the weight ratio of carboxymethylcellulose to dye is 3:1 to 0.5:1, more preferably 2:1 to 1.75:1 and still more preferably 1:5 to 1:1. At this ratio, it is believed that the release rate of dye is optimised and that very little, if any, dye remains in the residue at the end of the toilet life of the block.

The blocks of the present invention comprise a hydrophobe which acts as a solubility control agent to retard the dissolution of the block. Preferably the hydrophobe is selected from a terpene or a derivative thereof, C9-ii primary alcohols, non-ionic surfactants, perfumes and mixtures thereof. Preferably the hydrophobe is a terpene and still more preferably the hydrophobe is pine oil. In some blocks the hydrophobe is preferably a mixture of pine oil and C9-11 primary alcohols. In preferred blocks of the present invention the hydrophobe is present in an amount of 2 to 10% and more preferably 5 to 8% by weight of the total block.

Particularly preferred blocks of the present invention therefore comprise:

15 to 40 wt % alkane sulfonate;
2 to 15 wt % carboxymethylcellulose;
2 to 10 wt % hydrophobe; and
0 to 10 wt %, preferably 0.5 to 10 wt % dye;
wherein wt % is based on the total weight of the block.

Preferred blocks of the present invention further comprise one or more additional surfactants and preferably one or more additional anionic surfactants. Still more preferably the one or more additional anionic surfactants is a foam boosting surfactant. Yet more preferably the one or more additional anionic surfactants comprises an alpha-olefin sulphonate. Typically these are provided in the form of their sodium salts. Preferred α-olefin sulphonates are C₆₋₂₄ alkene sulphonates, particularly C₁₂₋₁₈ α-olefin sulphonates, especially C₁₄₋₁₆ olefin sulphonates. Particularly preferably the a-olefin sulphonate is a C₁₄₋₁₆ alkene sulfonate.

In preferred blocks of the present invention the one or more additional surfactants, e.g. the a-olefin sulphonate, is present in an amount of 2 to 10% and more preferably 5 to 9% and still more preferably 6 to 7.5% by weight of the total block. As with the alkane sulphonate, the release of alpha-olefin sulphonate provides cleansing activity and leads to the generation of foam in the toilet bowl during flushing which indicates to the user that the block is working.

Preferred blocks of the invention further comprise one or more density control agents. Density control agents are included to provide additional bulk to the blocks of the present invention and may enhance leaching of the active agent when the block is placed in water, rather than disintegration of the block. Preferably the density control agent ensures that the block exhibits a density greater than that of water which ensures that they will sink when suspended in a body of water, e.g., the water present within a cistern. Preferably the blocks exhibit a density in excess of about 1 g/cc of water, preferably a density in excess of about 1.4 g/cc of water and most preferably a density of at least about 1.6 g/cc of water. Preferred density control agents are soluble inorganic alkali, alkaline earth metal salt or hydrates thereof. Representative examples of density control agents include chlorides such as sodium chloride and magnesium chloride, carbonates and bicarbonates such as sodium carbonate and sodium bicarbonate, sulfates such as magnesium sulfate, copper sulfate, sodium sulfate and zinc sulfate and borax and borates such as sodium borate. Preferably, however, the density control agent comprises a sodium salt and particularly a sodium salt selected from sodium sulphate, sodium bicarbonate and sodium chloride. Especially preferably the sodium salt is sodium sulphate.

In preferred blocks of the present invention the density control agent is present in an amount of 0.1 to 45%, more preferably 10 to 40% and still more preferably 20 to 40% by weight of the total block.

Preferred blocks of the present invention further comprise at least one filler. Fillers generally modulate consumption of the block, i.e. prolong toilet life, and provide the block with a desirable texture. Any conventional filler may be used. The filler, when present, may be selected from an inorganic filler, such as for example silica, salts of alkali and/or alkaline-earth metals, clays and/or zeolites. Preferably the filler is a salt of an alkali and/or alkaline-earth metal. Representative examples of suitable fillers include magnesium sulfate, sodium sulfate or sodium carbonate. Magnesium sulphate is a preferred filler.

In preferred blocks of the present invention the filler is present in an amount of 0.1 to 10%, more preferably 2.5 to 7.5% and still more preferably 4 to 6% by weight of the total block.

Preferred blocks of the present invention further comprise a preservative. The preservative may also function as a disinfectant. Any conventional preservative may be used. Preservatives are primarily included to reduce the growth of undesired microorganisms within the blocks of the present invention during storage prior to use or while used. Exemplary useful preservatives include parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, sodium orthophenylphenate, and mixtures thereof. A particularly preferred preservative is sodium orthophenylphenate. In preferred blocks of the present invention the preservative is present in an amount of 0.1 to 0.4%, more preferably 0.15 to 0.3% and still more preferably about 0.2% by weight of the total block.

Blocks of the present invention optionally comprise further ingredients which are conventional in the art. These include, for example, processing aids, water softening agents, bleaches, whiteners, perfumes, germicides, stain inhibitors, binders and so on. Preferably, however, the blocks of the present invention are substantially free of phosphorous, organic or inorganic phosphonates, organic or inorganic phosphates, and salts or derivatives thereof.

A preferred block of the present invention comprises:

15 to 40 wt % sodium alkylbenzenesulphonate;
4.5 to 9 wt % carboxymethylcellulose;

### 1.0 to 6.4 wt % Acid Blue 9;

4.5 to 7.0 wt % pine oil;
3.2 to 9.0 wt % sodium alpha-olefin sulphonate;
0 to 7.0 wt % magnesium sulphate.3H₂O;
0 to 45 wt % sodium sulphate;
0 to 2 wt % C9-C11 alcohol blend; and
0 to 0.2 wt % sodium orthophenylphenate,
wherein wt % is based on the total weight of the block.

A particularly preferred block of the present invention comprises (e.g. consists of):

28 wt % sodium alkylbenzenesulphonate;
5.6 wt % carboxymethylcellulose;

### 5.0 wt % Acid Blue 9;

6.0 wt % pine oil;
7.2 wt % sodium alpha-olefin sulphonate;
5.5 wt % magnesium sulphate.3H₂O;
38.3 wt % sodium sulphate;
1.7 wt % sodium citrate;
0.03 wt % sodium bicarbonate;
1.5 wt % C9-C11 alcohol blend;
0.2 wt % sodium orthophenylphenate; and
0.97 wt % water,
wherein wt % is based on the total weight of the block.

The blocks of the present invention may optionally be partially or fully enveloped by a water-soluble layer and/or coating. Such layers and/or coatings may be advantageous to improve the handling of the blocks, e.g. coatings can sometimes help to prevent blocks sticking to one another following manufacture and/or during packaging. In many blocks of the present invention, however, a water-soluble coating is not required.

The present invention also relates to a packaged product comprising at least one block as hereinbefore described. Preferred packaged products comprises a plurality of the blocks, e.g. 4, 5, 6, 7 or 8 blocks. Any conventional packaging may be used.

The blocks of the present invention may be used with or without an ancillary device or structure, such as a holder or cage. Preferred blocks of the present invention are in-cistern blocks. In a preferred use of the blocks of the present invention, the blocks are supplied to the cistern of a toilet where they sink and typically rest upon the bottom until they are consumed. In another use one or more blocks are supplied to the interior of a lavatory appliance, e.g., a toilet bowl or interior of a urinal wherein the block(s) is within the path of flush water flushed through the sanitary appliance during its normal manner of use.

The manufacture of the blocks of the present invention is well within the capability of persons of ordinary skill in the art. The blocks may, for instance, be manufactured by preparing a mixture of an alkane sulfonate, a carboxymethylcellulose, a dye, and a hydrophobe; extruding the mixture into rod or bar form; and cutting the rod or bar into blocks. Typically all of the solid ingredients of the block are mixed in any suitable blending equipment followed by the addition of liquid ingredients under blending conditions. The resulting homogeneous blend is then extruded.

The composition for forming the blocks of the present invention is also an aspect of the invention. Thus, in a further aspect the present invention relates to a composition comprising:

15 to 40 wt % alkane sulfonate;
2 to 15 wt % carboxymethylcellulose;
2 to 10 wt % hydrophobe; and
0.5 to 10 wt %, dye,
wherein the weight ratio of alkane sulfonate to carboxymethylcellulose is 3:1 to 8:1.

Preferred compositions are the same as those set out above in relation to the block.

The use of a composition comprising an alkane sulfonate, a carboxymethylcellulose, a hydrophobe and a dye in the preparation of a lavatory cleansing block as hereinbefore described forms a further aspect of the invention.

The toilet life of the blocks of the present invention is preferably at least 7 days, more preferably at least 14 days and still more preferably at least 21 days. Preferably the toilet life is 7 to 60 days, more preferably 14 to 35 days and still more preferably about 28 days. Preferably the perceived toilet life of the blocks of the present invention is the same as the actual toilet life of the blocks of the present invention. Thus preferably the perceived toilet life of the blocks of the present invention is also least 7 days. Preferably the perceived toilet life is 7 to 60 days, more preferably 14 to 35 days and still more preferably about 28 days.

Preferred blocks of the present invention leave less than 3 wt % residue, based on the total weight of the block, at the end of its toilet life. More preferably the blocks of the present invention leave 0 to 2.5 wt %, more preferably 0 to 2 wt % and still more preferably 0 to 1 wt % residue, based on the total weight of the block at the end of its toilet life, e.g. as determined visually by the absence of color upon flushing. This is believed to be due to the presence of carboxymethylcellulose in the blocks which improve the release of its constituents enabling a more complete release to occur. This is highly advantageous since it means that less chemicals may be used to achieve a comparable actual and perceived performance over a given period of time, i.e. less chemicals are wasted in residue.

The blocks of the present invention are effective in cleaning surfaces of lavatory appliances, particularly toilet cisterns, toilet bowls, urinals, and bidets. Thus the present invention also relates to a method of cleansing a lavatory appliance comprising: placing a lavatory cleansing block as hereinbefore described within a lavatory appliance. Preferably the block is placed in the cistern or under the rim of the toilet bowl and most preferably in the cistern. The invention also relates to the use of a lavatory cleansing block as hereinbefore described for cleansing a lavatory, wherein the block is placed in the lavatory, e.g. in the cistern or under the rim.

### EXAMPLES

### Materials

All starting materials employed are commercially available.

Sodium dodecylbenzenesulphonate (80% active with 4.8 wt % sodium citrate, 13.2 wt % sodium sulphate and 2 wt % water) was obtained from Unger Fabrikker A. S.

Sodium sulphate was obtained from Brenntag.

Sodium alpha-olefin sulphonate (80% active with 16.7 wt % sodium sulphate, 0.3 wt % sodium bicarbonate and 3 wt % water) was obtained from Huntsman UK Ltd.

Pine oil was obtained from Chemox Pound Ltd.

Carboxymethyl cellulose (CMC, trade name Blanose 9H4F/Blanose 9H4) was obtained from Ashland. A 1% solution of the grade of CMC used had a viscosity range of 2500-4500 cP when tested at 25° C., 30 rpm and using an LV spindle, and had a 0.8-0.95 degree of substitution.

Magnesium sulphate.3H20 was obtained from Intermag Ltd.

Acid Blue 9 was obtained from Brenntag Ltd.

C9-C11 alcohol blend was obtained from Shell Chemicals.

Sodium orthophenylphenate was obtained from Lanxess Ltd.

Sodium polyacrylate was obtained from Brenntag.

Guar gum was obtained from Stanchem Ltd.

Cocomonoethanolamide was obtained from BASF UK Ltd.

Titanium dioxide was obtained from Brenntag.

### Analysis Methods

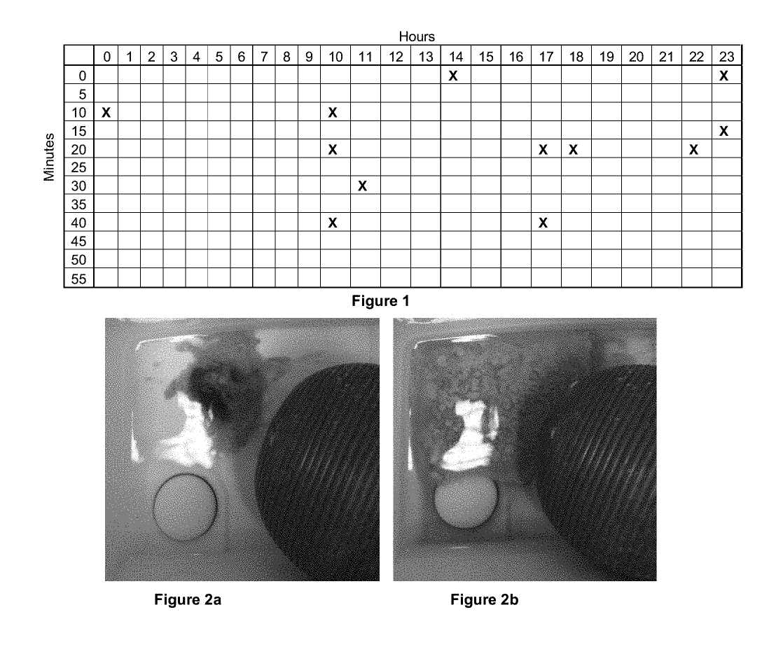

Spectrophotometric analysis of blue dye absorption was performed using a UV-visible spectrophotometer (Thermo Fisher Scientific, model Evolution 160). Samples were tested at a wavelength of 630 nm. Analysis was performed on a sample of water taken from the bowl after the 10:10 am flush each day (see FIG. 1).

### Preparative Example 1

### Preparation of a 24 g Block

A block was produced from the following composition (Block A):

| Component | Actual % w/w | g |
|---|---|---|
| Sodium | 28.0 | 6.7 |
| alkylbenzenesulphonate | | |
| Sodium sulphate | 38.3 | 9.2 |
| Sodium alpha-olefin | 7.2 | 1.7 |
| sulphonate | | |
| Pine Oil | 6.0 | 1.4 |
| Carboxymethyl cellulose | 5.6 | 1.3 |
| (CMC) | | |
| Magnesium sulphate•3H₂O | 5.5 | 1.3 |
| Sodium citrate | 1.7 | 0.4 |
| Sodium bicarbonate | 0.03 | 0.007 |
| Acid Blue 9 | 5.0 | 1.2 |
| C9-C11 alcohol blend | 1.5 | 0.4 |
| Sodium orthophenylphenate | 0.2 | 0.05 |
| Water | 0.97 | 0.23 |

The composition was extruded under standard conditions in a Sunlab P75 extruder to form a cylindrical body having a diameter of 42.5 mm. The cylindrical body was then cut into lengths to form blocks having a mass of 24 g each. The height or depth of each block was 11.6 mm. The total surface area of each block was 44 cm² and an effective surface area in use of 30 cm².

### Preparative Example 2

### Preparation of a 38 g Block

A comparative block was produced from the following composition (Block B):

| Component | Actual % w/w | g |
|---|---|---|
| Sodium | 39.2 | 14.9 |
| alkylbenzenesulphonate | | |
| Sodium sulphate | 26.53 | 10.1 |
| Sodium alpha-olefin | 10.4 | 4.0 |
| sulphonate | | |
| Sodium tripolyphosphate | 1.96 | 0.76 |
| Sodium bicarbonate | 0.04 | 0.015 |
| Pine Oil | 7.0 | 2.7 |
| Sodium polyacrylate | 4.5 | 1.7 |
| Acid Blue 9 | 3.0 | 1.1 |
| Guar gum | 3.0 | 1.1 |
| Cocomonoethanolamide | 2.0 | 0.8 |
| Titanium dioxide | 1.0 | 0.4 |
| Water | 1.37 | 0.5 |

The composition was extruded under standard conditions in a Sunlab P75 extruder to form a cylindrical body having a diameter of 47 mm. The cylindrical body was then cut into lengths to form blocks having a mass of 38 g each. The height or depth of each block was 17.5 mm. The total surface area of each block was 60 cm² and the total effective surface area was 43 cm².

The main differences between blocks A and B are as follows:

Block A is 24 g and block B is 38 g
Block A comprises carboxymethylcellulose whereas Block B comprises guar gum
Block A comprises 35.2 wt % of anionic surfactant whereas Block B comprises 49.6 wt %
The weight ratio of anionic surfactant to carboxymethylcellulose in Block A is 6.3:1 whereas the weight ratio of anionic surfactant to guar gum in Block B is 16.5:1.
The weight ratio of carboxymethylcellulose to dye in Block A is 1.1:1 whereas the weight ratio of guar gum to dye in Block B is 1:1.

### Example 1

### Automated Flush Protocol to Determine Toilet Life of the Blocks in Hard and Soft Water

A single block (either Block A or Block B, prepared as described above) was placed in the cistern of a wash-down UK 9-litre Magnia Armitage Shanks toilet and the toilet was flushed 12 times a day according to an automated flush protocol using a supply of either hard or soft water. The water was maintained at an ambient temperature of 16-19° C.

FIG. 1 is a diagram describing the automatic flush protocol employed to test the two different blocks. Each ‘X’ indicates the exact time at which the toilet was flushed each day. The first flush was programmed for 10:10 am every day. The flush protocol shown in FIG. 1 was designed to mimic typical household toilet use and therefore incorporates high frequency flush periods and extended dwell times between flushing.

### Hard Water

Block A functioned efficiently for 35 days. FIG. 2a shows the residue remaining in the cistern at day 34 of the test, which was analysed visually. The residue was further reduced by day 35 of the test. Block B functioned efficiently for 44 days. FIG. 2b shows the residue remaining in the cistern at day 44 of the test, which was analysed visually. It is clear to see that at the end of the life of the two blocks, the amount of residue remaining in the cistern is considerably less for Block A than for Block B.

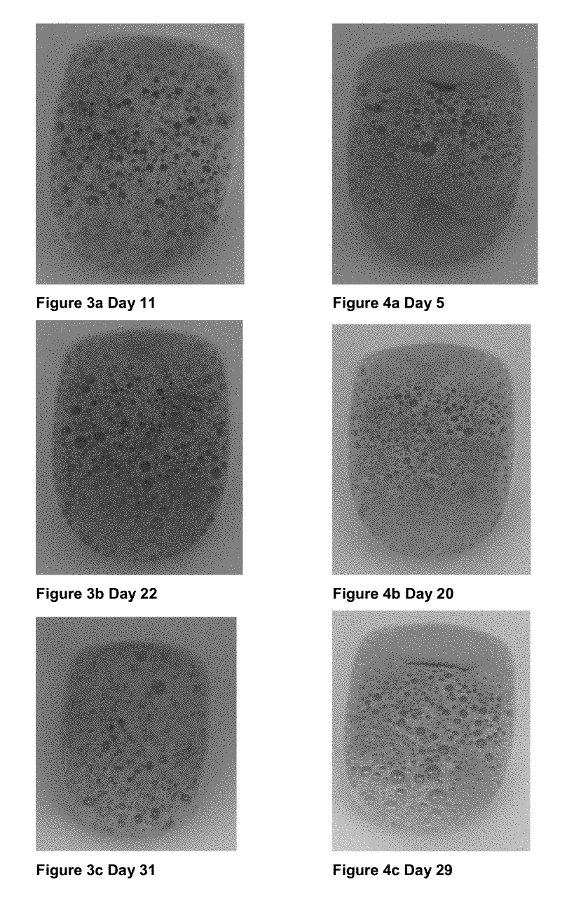

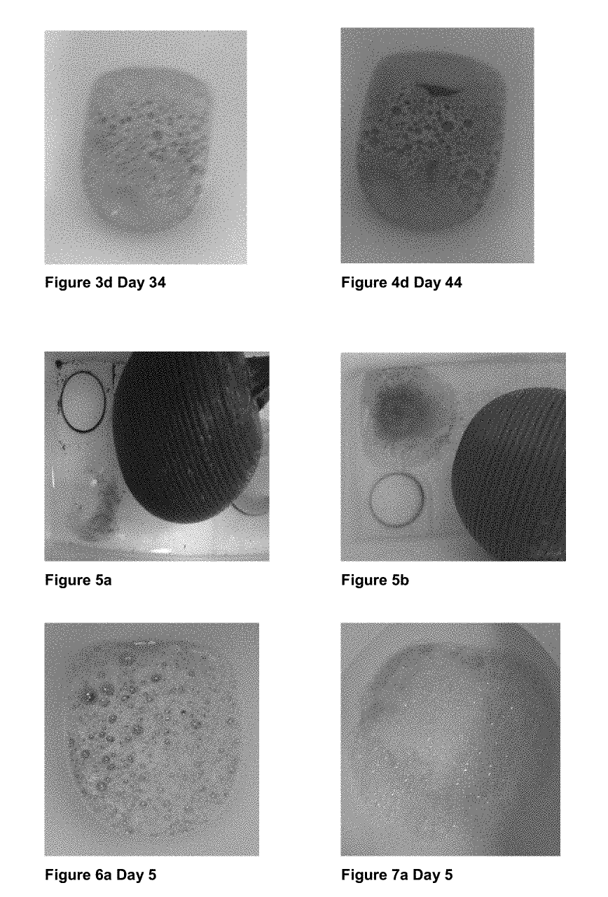

FIGS. 3a, 3b, 3c and 3d show the appearance of the toilet bowl comprising Block A immediately after flushing on days 11, 22, 31 and 34 of the test, respectively, which was also analysed visually. By day 34 the foam was of poor quality and the treated bowl water lacked color, confirming that the block had reached the end of its useful life.

FIGS. 4a, 4b, 4c and 4d show the appearance of the toilet bowl comprising Block B immediately after flushing on days 5, 20, 29 and 44 of the test, respectively, which was also analysed visually. By day 44 the foam was of poor quality and the treated bowl water lacked color, confirming that the block had reached the end of its useful life.

It is evident that over the entire life span of each of the blocks, the foam generated in the toilet bowl upon flushing with Block A is equal to or greater than the foam generated upon flushing with a Block B. This is unexpected given the lower amount of anionic surfactant present in Block A (both absolute and in terms of ratio) compared to Block B and the smaller size and surface area of Block A compared to Block B. Similarly the intensity of the blue color generated by Block A is similar to that of Block B, despite its smaller size and surface area. This means that both the actual and perceived effectiveness of the Block A over a 4 week period is at least comparable to that of Block B, despite its smaller size and surface area. This is believed to be due to the presence of carboxymethycellulose in the block of the invention.

### Soft Water

Block A functioned efficiently for 28 days. FIG. 5a shows the residue remaining in the cistern at day 28 of the test, which was analysed visually. Block B functioned efficiently for 34 days. FIG. 5b shows the residue remaining in the cistern at day 34 of the test, which was analysed visually. It is clear to see that at the end of the life of the two blocks, the amount of residue remaining in the cistern is considerably less for Block A than for Block B.

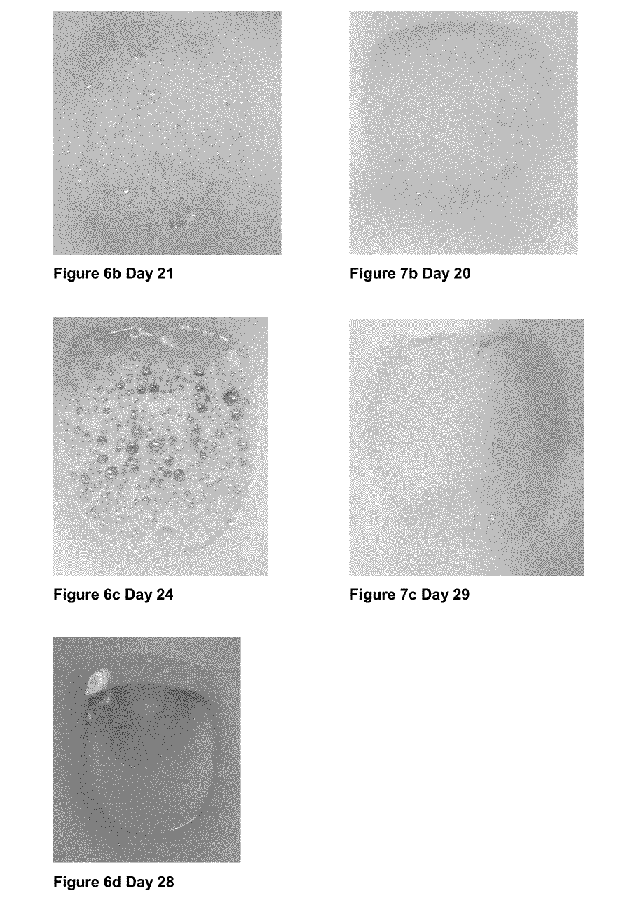

FIGS. 6a, 6b, 6c and 6d show the appearance of the toilet bowl comprising Block A immediately after flushing on days 5, 21, 24 and 28 of the test, respectively, which was also analysed visually. By day 28 there was no foam or color present in the toilet bowl, confirming that the block was exhausted and had reached the end of its useful life.

FIGS. 7a, 7b and 7c show the appearance of the toilet bowl comprising Block B immediately after flushing on days 5, 20 and 29 of the test, respectively, which was also analysed visually.

Although the foam generated in the toilet bowl upon flushing with Block B was generally greater than the foam generated upon flushing with Block A, it is clear to see from the Figures that the foam generated upon flushing with Block A is satisfactory over the life span of the block. It can therefore be seen that Block A produces sufficient foam over its lifetime compared to the larger Block B, despite the lower total size and surface area of Block A as well as its lower amount of anionic surfactant. It is also clear that the intensity of the blue color generated with Block A is much greater during the lifetime of the block than with Block B. This is believed to be due to the presence of carboxymethylcellulose instead of guar gum in the block which releases the dye more readily. This correlates with the reduced amount of residue that is left at the end of the toilet lifetime in the cistern.

This means that both the actual and perceived effectiveness of the Block A over a 4 week period is at least comparable to that of Block B, despite its smaller size and surface area.

### Example 2

### Evaluation of Block Dye Release

A single Block A was subjected to the automated flush protocol described above using a supply of hard water. A sample of the toilet bowl water was taken immediately after the 10:10 am flush every day. Spectrophotometric analysis was then performed on the sample to determine the amount of Acid Blue 9 dye released into the toilet bowl water upon flushing.

The above test was repeated for Block A using a supply of soft water and also for Block B using a supply of both hard and soft water.

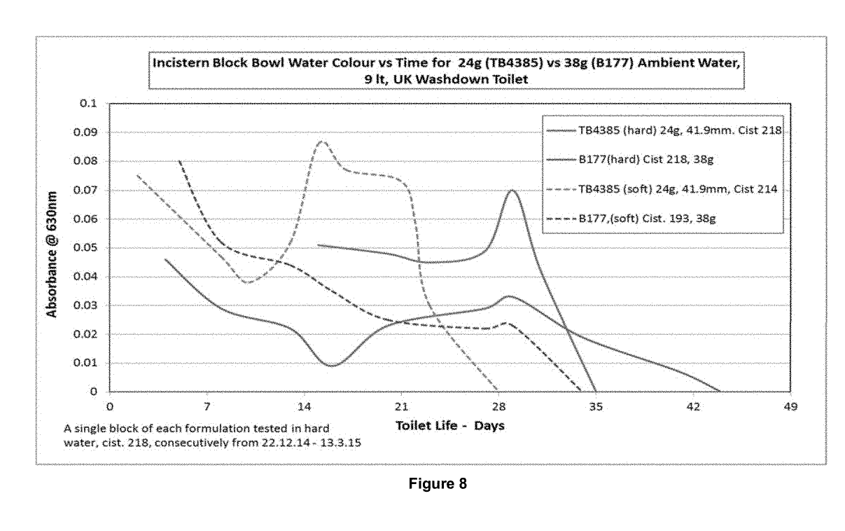

FIG. 8 is a graph showing the absorbance (at λₘₐₓ=630 nm) against time for each of the four tests. The solid blue line shows the results for Block A tested in hard water, the solid red line shows the results for Block B tested in hard water, the dotted blue line shows the results for Block A tested in soft water and the dotted red line shows the results for Block B tested in soft water.

Upon comparison of the results for Block A and Block B in hard water, it is clear to see that the dye release profile is significantly greater for Block A, i.e. the absorbance values are higher for Block A at every time point. This shows Block A releases more dye into the toilet bowl than Block B, resulting in the toilet bowl water having a superior blue color after flushing compared to the larger Block B. This is also verified by the visual results discussed above in example 1.

Upon comparison of the results for Block A and Block B in soft water, the dye release profile is generally greater for Block A, i.e. the absorbance values are higher for Block A at most time points. Considerably higher absorption values were observed for Block A between days 15 and 23, indicating that Block A experienced an accelerated erosion rate during this period as a result of the soft water conditions. Under soft water conditions, Block A therefore also releases more dye into the toilet bowl than Block B, resulting in the toilet bowl water having a superior blue color after flushing.

FIG. 8 also indicates the useful life of the blocks when tested under both hard and soft water conditions. The intersection of each of the line graphs with the horizontal axis indicates the time point at which the absorbance value is zero and therefore when the blocks are no longer releasing dye upon flushing. As discussed above, the useful life of Block A was 35 days in hard water and 28 days in soft water whilst the useful life of Block B was 44 days in hard water and 34 days in soft water. This shows that the useful toilet life of Block A meets expectations with regards to useful life, despite Block A being significantly smaller in size than Block B.

What is claimed is:

1. A lavatory cleansing block comprising:
an alkane sulfonate;
a carboxymethylcellulose;
a hydrophobe; and
optionally a dye,
wherein said alkane sulfonate is present in an amount of 15 to 40% by weight of the total block, the weight ratio of alkane sulfonate to carboxymethylcellulose is 3:1 to 8:1 and the total weight of the block is less than 25 g.

2. The lavatory cleansing block as claimed in claim 1, wherein said block has a total surface area of 25 to 55 cm².

3. The lavatory cleansing block as claimed in claim 1, wherein said block has a circular cross section.

4. The lavatory cleansing block as claimed in claim 3, having a diameter of 2 to 6.5 cm.

5. The lavatory cleansing block as claimed in claim 3, having a height of 0.5 to 5.5 cm.

6. The lavatory cleansing block as claimed in claim 1, wherein said alkane sulfonate is sodium alkylbenzenesulfonate.

7. The lavatory cleansing block as claimed in claim 1, wherein said carboxymethylcellulose has a viscosity range of 1000 to 8000 cP when tested as a 1% solution in water at 25° C., 30 rpm and using a rheometer.

8. The lavatory cleansing block as claimed in claim 1, wherein said carboxymethylcellulose has a degree of substitution of 0.6-1.45.

9. The lavatory cleansing block as claimed in claim 1, wherein said carboxymethylcellulose is present in an amount of 2 to 15% by weight of the total block.

10. The lavatory cleansing block as claimed in claim 1, wherein said dye is Acid Blue 9.

11. The lavatory cleansing block as claimed in claim 1, wherein said dye is present in an amount of 0.5 to 10% by weight of the total block.

12. The lavatory cleansing block as claimed in claim 1, wherein the weight ratio of carboxymethylcellulose to dye is 3:1 to 0.5:1.

13. The lavatory cleansing block as claimed in claim 1, wherein said hydrophobe is selected from a terpene or a derivative thereof, C₉₋₁₁ primary alcohols, non-ionic surfactants, perfumes and mixtures thereof.

14. The lavatory cleansing block as claimed in claim 13, wherein said hydrophobe is pine oil or a mixture of pine oil and C₉₋₁₁ primary alcohols.

15. The lavatory cleansing block as claimed in claim 1, wherein said hydrophobe is present in an amount of 2 to 10% by weight of the total block.

16. The lavatory cleansing block as claimed in claim 1 comprising:
15 to 40 wt % alkane sulfonate;
2 to 15 wt % carboxymethylcellulose;
2 to 10 wt % hydrophobe; and
0 to 10 wt %; and
wherein wt % is based on the total weight of the block.

17. The lavatory cleansing block as claimed in claim 1, further comprising one or more additional surfactants.

18. The lavatory cleansing block as claimed in claim 1, wherein said one or more additional anionic surfactants comprises an alpha-olefin sulphonate.

19. The lavatory cleansing block as claimed in claim 17, wherein said one or more additional surfactants are present in an amount of 2 to 10% by weight of the total block.

20. The lavatory cleansing block as claimed in claim 1, further comprising a density control agent.

21. The lavatory cleansing block as claimed in claim 20, wherein said density control agent is sodium sulphate.

22. The lavatory cleansing block as claimed in claim 20, wherein said density control agent is present in an amount of 0.1 to 45% by weight of the total block.

23. The lavatory cleansing block as claimed in claim 1, further comprising 0.1 to 10 wt % magnesium sulphate.

24. The lavatory cleansing block as claimed in claim 1, further comprising 0.1 to 0.4 by weight of the total block of sodium orthophenylphenate.

25. The lavatory cleansing block as claimed in claim 1, comprising:
15 to 40 wt % sodium alkylbenzenesulphonate;
4.5 to 9 wt % carboxymethylcellulose;
1.0 to 6.4 wt % Acid Blue 9;
4.5 to 7.0 wt % pine oil;
3.2 to 9.0 wt % sodium alpha-olefin sulphonate;
0 to 7.0 wt % magnesium sulphate.3H₂O;
0 to 45 wt % sodium sulphate;
0 to 2 wt % C9-C11 alcohol blend; and
0 to 0.2 wt % sodium orthophenylphenate,
wherein wt % is based on the total weight of the block.

26. The lavatory cleansing block as claimed in claim 1, comprising:
28 wt % sodium alkylbenzenesulphonate;
5.6 wt % carboxymethylcellulose;
5.0 wt % Acid Blue 9;
6.0 wt % pine oil;
7.2 wt % sodium alpha-olefin sulphonate;
5.5 wt % magnesium sulphate.3H20;
38.3 wt % sodium sulphate;
1.7 wt % sodium citrate;
0.03 wt % sodium bicarbonate;
1.5 wt % C9-C11 alcohol blend;
0.2 wt % sodium orthophenylphenate; and
0.97 wt % water,
wherein wt % is based on the total weight of the block.

27. The lavatory cleansing block as claimed in claim 1 which is substantially free of guar gum.

28. The lavatory cleansing block as claimed in claim 1 which is substantially free of phosphorous, organic or inorganic phosphonates, organic or inorganic phosphates, and salts or derivatives thereof

29. The lavatory cleansing block as claimed in claim 1, which is at least partially enveloped by a water soluble layer or coating.

30. The lavatory cleansing block as claimed in claim 1, which is an in-cistern block.

31. The lavatory cleansing block as claimed in claim 1, which has a toilet life of at least 7 days.

32. The lavatory cleansing block as claimed in claim 1, which leaves less than 3 wt % residue, based on the total weight of the block, at the end of its toilet life.

33. A method of cleansing a lavatory appliance, comprising: placing a lavatory cleansing block as claimed in claim 1 within said lavatory appliance.

34. A composition comprising:
15 to 40 wt % alkane sulfonate;
2 to 15 wt % carboxymethylcellulose;
2 to 10 wt % hydrophobe; and
0.5 to 10 wt %, dye,
wherein the weight ratio of alkane sulfonate to carboxymethylcellulose is 3:1 to 8:1.
